(19) United States
(12) Patent Application Publication
(10) Pub. No.: US 2018/0224898 A1
(43) Pub. Date: Aug. 9, 2018

(54) HINGE STRUCTURE AND ELECTRONIC DEVICE

(71) Applicant: Acer Incorporated, New Taipei City (TW)

(72) Inventor: Yu-Chin Huang, New Taipei City (TW)

(73) Assignee: Acer Incorporated, New Taipei City (TW)

(21) Appl. No.: 15/483,629

(22) Filed: Apr. 10, 2017

(30) Foreign Application Priority Data
Feb. 7, 2017 (TW) 106103966

(51) Int. Cl. G06F 1/16; F16C 11/04; E05D 7/00; E05D 11/08

(52) U.S. Cl. CPC G06F 1/1681; F16C 11/04; E05Y 2900/606; E05D 11/08; G06F 1/1616; E05D 7/00

(57) ABSTRACT

A hinge structure includes a pivot, a bracket and a torsion element. The bracket is sleeved on the pivot and adapted to rotate relative to the pivot. The bracket surrounds to form a receiving space, and the receiving space surrounds the pivot. The torsion element is sleeved on the pivot and located in the receiving space. One of the two, which is between the torsion element and the pivot and between the torsion element and the bracket, has an internal thread and an external thread and being screwed with each other, and the other one has a non-circular cross-section, so that the torsion element moves in the receiving space in an extending direction of the pivot when the bracket is rotated relative to the pivot.

### CROSS-REFERENCE TO RELATED APPLICATION

This application claims the priority benefit of Taiwan application serial no. 106103966, filed on Feb. 7, 2017. The entirety of the above-mentioned patent application is hereby incorporated by reference herein and made a part of this specification.

### BACKGROUND OF THE INVENTION

### Field of the Invention

The invention relates to a hinge structure and an electronic device, and particularly relates to a hinge structure capable of saving an internal space of a product and an electronic device using the same.

### Description of Related Art

A tablet computer and a base, or a display screen and a host, which are generally combined into a notebook, are mainly coupled to each other via a hinge structure, so that the user can rotate or open/close the tablet computer or the display screen. The currently used hinge structure of the notebook on the market can be roughly divided into a spring type hinge structure and a wrap type hinge structure.

The spring type hinge structure generates a torsion by a spring force of the spring and a friction. To increase the torsion, the number of the spring needs to be increased. Therefore, it is easy to cause the increase in size of the spring type hinge structure, thereby affecting an application of an internal space and beautiful of the product. Furthermore, the more the number of the spring of the spring type hinge structure, the longer the required assembly time. Besides, the wrap type hinge structure generates the torsion using an iron plate friction center axis. To increase the torsion, a friction area needs to be increased. Therefore, it is easy to cause the increase in size of the wrap type hinge structure, so as to affect the application of the internal space and beautiful of the product. Additionally, the iron plate generating the friction is formed by a punching process or a bending machine process. The aforementioned processes are easy to cause the unstable torsion due to the manufacturing process, thereby affecting the yield.

### SUMMARY OF THE INVENTION

The invention provides a hinge structure capable of saving an internal space of the product and being easy to adjust and maintain.

The invention also provides an electronic device using the aforementioned hinge structure.

The invention provides a hinge structure including a pivot, a bracket and a torsion element. The bracket is sleeved on the pivot and adapted to rotate relative to the pivot. The bracket surrounds to form a receiving space, and the receiving space surrounds the pivot. The torsion element is sleeved on the pivot and located in the receiving space. One of the two, which is between the torsion element and the pivot and between the torsion element and the bracket, has an internal thread and an external thread and being screwed with each other, and the other one has a non-circular cross-section, so that the torsion element moves in the receiving space in an extending direction of the pivot when the bracket is rotated relative to the pivot.

According to an embodiment of the invention, the bracket has the internal thread formed toward the receiving space. The torsion element has the external thread. The torsion element is screwed with the bracket. The pivot has the non-circular cross-section in the receiving space.

According to an embodiment of the invention, the hinge structure further includes a packing element sleeved on the pivot and together surrounding to form the receiving space with the bracket. When the bracket is rotated relative to the pivot, the packing element is rotated relative to the pivot accordingly.

According to an embodiment of the invention, the internal thread includes a first internal thread and a second internal thread. The bracket and the packing element have the first internal thread and the second internal thread formed toward the receiving space respectively. The torsion element has the external thread. One of the bracket and the packing element is screwed with the torsion element. The pivot has the non-circular cross-section in the receiving space.

According to an embodiment of the invention, the first internal thread of the bracket and the second internal thread of the packing element have different specifications.

According to an embodiment of the invention, the hinge structure further includes a position-limiting element disposed at one side of the pivot to limit the movement of the bracket and the packing element in the extending direction of the pivot. The packing element is located between the position-limiting element and the bracket. When the bracket is rotated relative to the pivot, the packing element is synchronously rotated with the bracket. The bracket drives the torsion element to move in the extending direction of the pivot, so that the torsion element is moved relative to the pivot, the bracket and the packing element to generate a frictional resistance.

According to an embodiment of the invention, the hinge structure further includes an another bracket sleeved on one side of the pivot.

The invention provides an electronic device including the hinge structure, a base unit and a display unit. One of the pivot and the bracket is fixed to the base unit, and the other one of the pivot and the bracket is fixed to the display unit.

The invention provides an electronic device including the hinge structure, a base unit and a display unit. One of the another bracket and the bracket is fixed to the base unit, and the other one of the another bracket and the bracket is fixed to the display unit.

Based on the above, in the design of the hinge structure of the invention, one of the two, which is between the torsion element and the pivot and between the torsion element and the bracket, has an internal thread and an external thread and being screwed with each other, and the other one has a non-circular cross-section, so that the torsion element moves in the receiving space in an extending direction of the pivot when the bracket is rotated relative to the pivot. Therefore, the display unit of the electronic device of the invention may be pivoted relative to the pivot via the bracket of the hinge structure to be opened, closed, or supported relative to the base unit. In comparison with a conventional spring type hinge structure and a wrap type hinge structure, in the hinge structure of the invention, the increase in size due to the increased number of the spring of the conventional spring type hinge structure, which may affect the application of the internal space and beautiful of the product, may be avoided, and the unstable torsion of the wrap type hinge structure caused by the manufacturing process, thereby generating the problem of yield, may also be avoided. In short, the hinge structure of the invention may have the advantages of saving the internal space of the product and being easy to adjust and maintain.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an electronic device according to an embodiment of the invention.

FIG. 2 is a schematic three-dimensional view illustrating a hinge structure in the electronic device of FIG. 1.

FIG. 3A and FIG. 3B are schematic cross-sectional views illustrating a bracket of the hinge structure in FIG. 2 before and after rotating respectively.

FIG. 4A and FIG. 4B are schematic cross-sectional views illustrating a bracket of a hinge structure according to another embodiment of the invention before and after rotating respectively.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

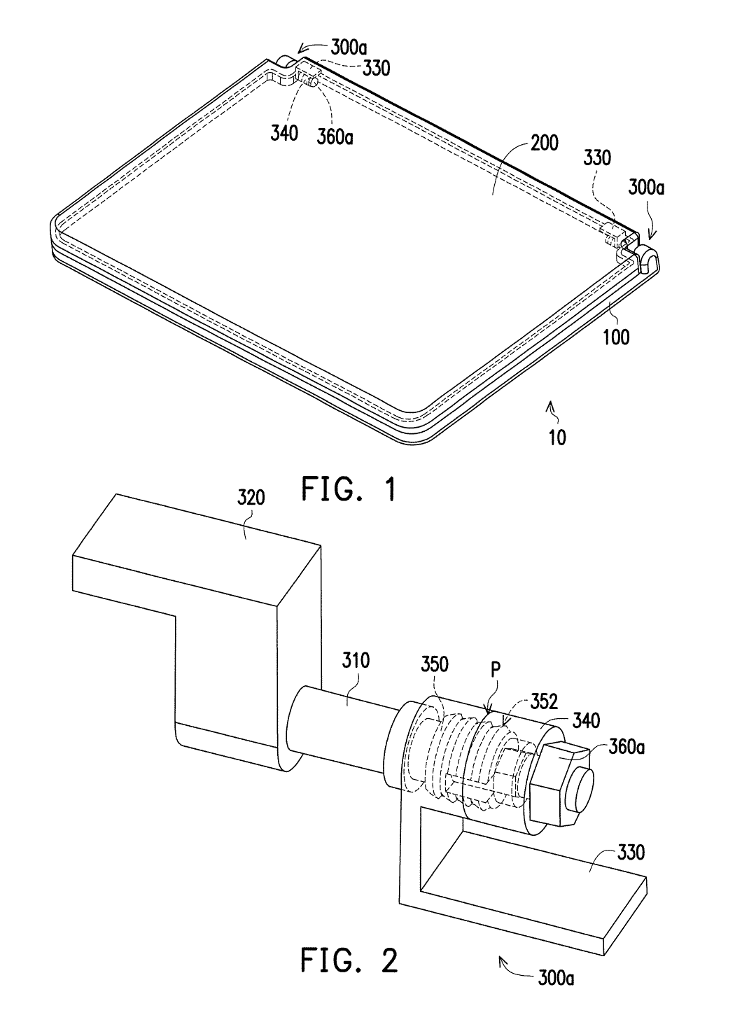

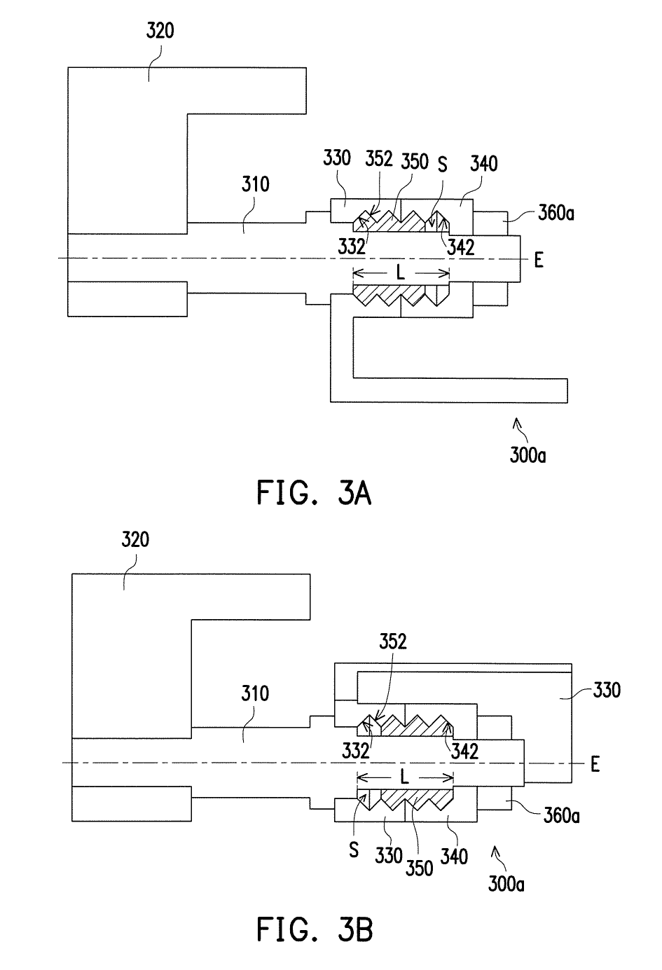

FIG. 1 is a schematic view illustrating an electronic device according to an embodiment of the invention. FIG. 2 is a schematic three-dimensional view illustrating a hinge structure in the electronic device of FIG. 1. FIG. 3A and FIG. 3B are schematic cross-sectional views illustrating a bracket of the hinge structure in FIG. 2 before and after rotating respectively.

Referring to FIG. 1, in the embodiment, an electronic device 10 includes a base unit 100, a display unit 200 and a hinge structure 300a. Herein, the electronic device 10 is a notebook, for example. The base unit 100 is embodied as a host of the notebook. The display unit 200 is embodied as a display screen of the notebook, and the display unit 200 is pivoted onto the base unit 100. However, the type of the electronic device 10 is not limited to the embodiment. In other embodiments not shown, the electronic device may also be a combination of a tablet computer and an expansion base thereof.

Referring to FIG. 1, FIG. 2 and FIG. 3A at the same time, the hinge structure 300a of the embodiment includes a pivot 310, an another bracket 320, a bracket 330, a packing element 340, a torsion element 350 and a position-limiting element 360a. The another bracket 320 is sleeved on one side of the pivot 310 and fixed to the pivot 310. In other possible embodiments of the invention, the another bracket may also be fixed with the pivot in one piece or integrally formed with the pivot. The bracket 330 is sleeved on the pivot 310 and can be rotated around the pivot 310. The another bracket 320 is fixed to one of the base unit 100 and the display unit 200, and the bracket 330 is fixed to the other one of the base unit 100 and the display unit 200. For example, the another bracket 320 is fixed to the base unit 100, and the bracket 330 is fixed to the display unit 200. Thus, the display unit 200 may be pivoted around the pivot 310 via the bracket 330 to be opened or closed relative to the base unit 100. Additionally, it is also possible that the pivot 310 is directly fixed to the base unit 100 or the display unit 200 without using the another bracket 320.

Furthermore, the packing element 340 of the embodiment is sleeved on the pivot 310. The bracket 330, the packing element 340 and the pivot 310 define a receiving space S. More specifically, the bracket 330 has a ring-shaped receiving portion surrounding a periphery of the pivot 310. The packing element 340 also has a ring-shaped receiving portion surrounding the periphery of the pivot 310. The receiving portion of the bracket 330 and the receiving portion of the packing element 340 are side by side and front and rear connected with each other in an extending direction E of the pivot 310, so that the two receiving portions surrounds to form the receiving space S at the periphery of the pivot 310. The bracket 330 and the packing element 340 have internal threads 332 and 342 inwardly formed toward the receiving space S at each of the receiving portions respectively. The pivot 310 has a polygonal non-circular cross-section or other non-circular cross-sections in the receiving space S, for example. In the e mbodiment, for example, the pivot 310 in the receiving space S is hexagonal.

The torsion element 350 is sleeved on the pivot 310 and located in the receiving space S. The torsion element 350 is adapted to move in the extending direction E of the pivot 310 but cannot rotate relative to the pivot 310 affected by the non-circular cross-section of the pivot 310. The torsion element 350 has an external thread 352 screwed with both or one of the internal threads 332 and 342 in the bracket 330 and the packing element 340.

The position-limiting element 360a is a screw nut, for example, disposed at the other side of the pivot 310. That is, the packing element 340 is located between the position-limiting element 360a and the bracket 330. The position-limiting element 360a may pack toward the packing element 340 to limit the movement of the bracket 330 and the packing element 340 in the extending direction E of the pivot 310, so that the bracket 330 and the packing element 340 can be rotated accordingly when rotating relative to the pivot 310. In the embodiments as shown in FIG. 2 and FIG. 3, surfaces that the bracket 330 and the packing element 340 are in contact with each other are flat surfaces. However, in order to make the bracket 330 and the packing element 340 be rotated accordingly relative to the pivot 310, it is also possible to roughen the surfaces that the bracket 330 and the packing element 340 are in contact with each other, mold them into groove-like shapes, or mold them into a bump and a groove with a complementary shape.

Based on the above structure, referring to FIG. 1, FIG. 3A and FIG. 3B at the same time, when the bracket 330 is rotated relative to the pivot 310, the packing element 340 is synchronously rotated with the bracket 330. The torsion element 350 located in the receiving space S cannot rotate due to the non-circular cross-section of the pivot 310, so that the torsion element 350 moves in the extending direction E of the pivot 310 driven by the internal threads 332 and 342 of the bracket 330 and the packing element 340, and a frictional resistance can be generated from a contact surface of the torsion element 350 and the pivot 310 and thread contact surfaces of the torsion element 350 and the bracket 330, and the torsion element 350 and the packing element 340 to provide a torsion. Therefore, the display unit 200 of the electronic device 10 of the embodiment can be pivoted relative to the pivot 310 via the bracket 330 of the hinge structure 300a to be opened, closed or supported relative to the base unit 100, and a blocking sense or the torsion required by the supporting are provided by the hinge structure 300a when being opened, closed and supported.

Based on the above, the hinge structure 300a may generate the frictional resistance from the contact surface of the torsion element 350 and the pivot 310 and the thread contact surfaces of the torsion element 350 and the bracket 330, and the torsion element 350 and the packing element 340. In other possible embodiments of the invention, the packing element may also be omitted, and the frictional resistance may still be provided from the thread contact surface of the torsion element and the bracket and the contact surface of the torsion element and the pivot, so as to have similar effects as the aforementioned embodiments.

Additionally, in another possible embodiment of the invention, the pivot may have the external thread in the receiving space. The torsion element is sleeved on the pivot and has the internal thread, so that the torsion element is screwed with the pivot. The contact surfaces of the torsion element and the bracket, and the torsion element and the packing element have non-circular cross-sections. Thus, when the bracket and the packing element are rotated relative to the pivot, the torsion element is driven to be rotated accordingly, and the torsion element moves in the extending direction of the pivot affected by the external thread of the pivot. Similarly, the frictional resistance may be generated from the contact surface of the torsion element and the pivot and the contact surfaces of the torsion element and the bracket, and the torsion element and the pivot, so as to have similar effects as the aforementioned embodiments.

In the aforementioned embodiments, the packing element 340 may generate the friction by the thread and the torsion element 350, so that the torsion element 350 and the pivot 310 are packingly rubbed to generate the torsion. When the user or the manufacturers need to adjust the torsion, it can be changed to adjust the specification of the packing element 340, so that the internal thread 342 of the packing element and the internal thread 332 of the bracket 330 have one or more different specifications except for the pitch. For example, the internal thread 342 of the packing element 340 has a smaller inner diameter, a larger tooth height, or a smaller addendum angle, so that the internal thread 342 of the packing element 340 inwardly presses toward the torsion element 350 to obtain a larger frictional resistance, so as to generate a larger torsion. Thus, the effects of easy to adjust and maintain can be obtained by using the packing element 340.

It should be mentioned that, as shown in FIG. 2, a contact surface P of the packing element 340 and the bracket 330 herein is shown as a flat surface. However, in other embodiments not shown, to increase the friction between the packing element and the bracket, a surface treatment, such as embossing or roughening, may also be perfoinied on a contact side surface of the packing element and the bracket and a contact side surface of the bracket and the packing element, so that the contact surface of the packing element and the bracket is a non-planar surface, which is still within the scope of the invention.

It should be mentioned that, in addition to the selection of the packing element 340, the magnitude of the torsion of the embodiment is also positively correlated with a length L of the receiving space S. Specifically, when the length L of the receiving space S is longer, the torsion element 350 may have a longer length. It indicates that the hinge structure 300a may provide a larger torsion and supporting force, so that the display unit 200 may be opened at a larger angle relative to the base unit 100, and the hinge structure 300a can be adapted to the electronic device 10 with a larger size.

The magnitude of the torsion of the hinge structure 300a of the embodiment depends on the packing force of the packing element 340 compared to the conventional spring type hinge structure and the wrap type hinge structure. Thus, if the torsion needs to be adjusted, it only needs to replace the packing element. Therefore, the increase in size due to the increased number of the spring of the conventional spring type hinge structure, which may affect the application of the internal space and beautiful of the product, can be avoided. Also, the unstable torsion of the wrap type hinge structure caused by the manufacturing process, thereby generating the problem of yield, can be avoided. In short, the hinge structure 300a of the embodiment may have the advantages of saving the internal space of the product and being easy to adjust and maintain.

It should be noted that, the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

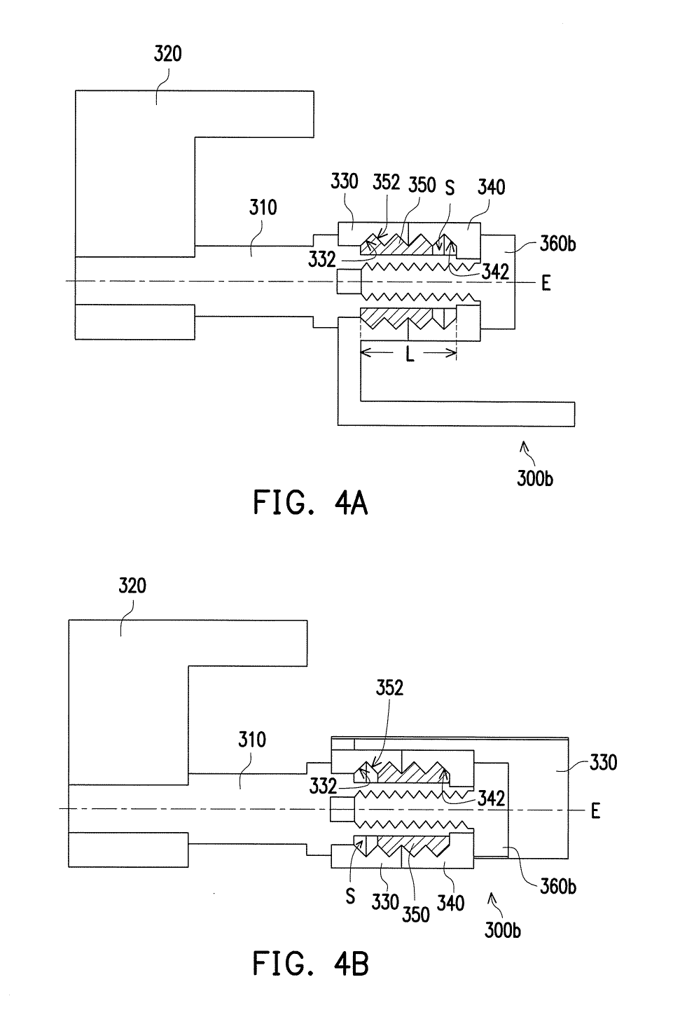

FIG. 4A and FIG. 4B are schematic cross-sectional views illustrating a bracket of a hinge structure according to another embodiment of the invention before and after rotating respectively. Referring to FIG. 3A, FIG. 3B, FIG. 4A and FIG. 4B at the same time, a hinge structure 300b of the embodiment is similar to the hinge structure 300a in FIG. 3A and FIG. 3B. The difference between the two is that, a position-limiting element 360b of the hinge structure 300b of the embodiment is embodied as a screw. The position-limiting element 360b penetrates a portion of the pivot 310 and is locked onto one end of the pivot 310, which can provide the similar effects as the aforementioned embodiments.

In summary, the magnitude of the torsion of the hinge structure of the invention depends on the packing force of the packing element compared to the conventional spring type hinge structure and the wrap type hinge structure. Thus, if the torsion needs to be adjusted, it only needs to replace the packing element. Therefore, the increase in size due to the increased number of the spring of the conventional spring type hinge structure, which may affect the application of the internal space and beautiful of the product, can be avoided. Also, the unstable torsion of the wrap type hinge structure caused by the manufacturing process, thereby generating the problem of yield, can be avoided. In short, the hinge structure of the invention may have the advantages of saving the internal space of the product and being easy to adjust and maintain.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A hinge structure, comprising:
a pivot;
a bracket, sleeved on the pivot and adapted to rotate relative to the pivot, wherein the bracket surrounds to form a receiving space, and the receiving space surrounds the pivot; and
a torsion element, sleeved on the pivot and located in the receiving space, wherein one of the two, which is between the torsion element and the pivot and between the torsion element and the bracket, has an internal thread and an external thread and being screwed with each other, and the other one has a non-circular cross-section, so that the torsion element moves in the receiving space in an extending direction of the pivot when the bracket is rotated relative to the pivot.

2. The hinge structure according to claim 1, wherein the bracket has the internal thread formed toward the receiving space, the torsion element has the external thread, the torsion element is screwed with the bracket, and the pivot has the non-circular cross-section in the receiving space.

3. The hinge structure according to claim 1, further comprising:
a packing element, sleeved on the pivot and together surrounding to form the receiving space with the bracket, wherein when the bracket is rotated relative to the pivot, the packing element is rotated relative to the pivot accordingly.

4. The hinge structure according to claim 3, wherein the internal thread comprises a first internal thread and a second internal thread, the bracket and the packing element have the first internal thread and the second internal thread formed toward the receiving space respectively, the torsion element has the external thread, one of the bracket and the packing element is screwed with the torsion element, and the pivot has the non-circular cross-section in the receiving space.

5. The hinge structure according to claim 4, wherein the first internal thread of the bracket and the second internal thread of the packing element have different specifications.

6. The hinge structure according to claim 3, further comprising:
a position-limiting element, disposed at one side of the pivot to limit the movement of the bracket and the packing element in the extending direction of the pivot, wherein the packing element is located between the position-limiting element and the bracket, when the bracket is rotated relative to the pivot, the packing element is synchronously rotated with the bracket, and the bracket drives the torsion element to move in the extending direction of the pivot, so that the torsion element is moved relative to the pivot, the bracket and the packing element to generate a frictional resistance.

7. The hinge structure according to any of claim 1, further comprising:
an another bracket, sleeved on one side of the pivot.

8. An electronic device, comprising:
the hinge structure according to any of claim 1;
a base unit, one of the pivot and the bracket being fixed to the base unit; and
a display unit, the other one of the pivot and the bracket being fixed to the display unit.

9. An electronic device, comprising:
the hinge structure according to claim 7;
a base unit, one of the another bracket and the bracket being fixed to the base unit; and
a display unit, the other one of the another bracket and the bracket being fixed to the display unit.
